(19) United States
(12) Patent Application Publication
(10) Pub. No.: US 2008/0320509 A1
(43) Pub. Date: Dec. 25, 2008

(54) Quantitative Assessment of Marketing Strategies

(76) Inventors: Joseph E. Gustafson, Sherborn, MA (US); Gregory A. Flynn, Acton, MA (US); Chris Paul, Lincoln, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/144,954

(22) Filed: Jun. 24, 2008

Related U.S. Application Data
(63) Continuation-in-part of application No. 10/890,028, filed on Jul. 13, 2004.
Application No. 10/890,028 is a continuation-in-part of application No. 10/052,154, filed on Jan. 16, 2002, now Pat. No. 6,968,506.
(60) Provisional application No. 60/262,127, filed on Jan. 16, 2001.
(60) Provisional application No. 60/946,170, filed on Jun. 26, 2007.

(51) Int. Cl. H04N 7/16

(52) U.S. Cl. 725/23

(57) ABSTRACT

Systems and methods allow business and marketing professionals to quantitatively measure the success of distributed marketing information and the quality of the sales opportunity at any given phase in the sales process.

### CROSS-REFERENCE TO RELATED APPLICATIONS

This application is a Continuation-in-Part of pending U.S. patent application Ser. No. 10/890,028, filed Jul. 13, 2004, which is a Continuation-in-Part of U.S. Pat. No. 6,968,506, filed Jan. 16, 2002, which claims priority to and the benefit of U.S. Provisional Application No. 60/262,127, filed Jan. 16, 2001. The present application further claims priority to and the benefit of U.S. Provisional Patent Application No. 60/946,170, filed Jun. 26, 2007, which is hereby incorporated by reference in its entirety.

### FIELD OF THE INVENTION

The invention relates generally to the quantitative assessment of the success of marketing messages, and particularly to the tracking of viewer responses to electronic marketing presentations.

### BACKGROUND

The marketing initiatives employed by a business can be crucial to its success in the marketplace. Accordingly, marketing organizations have struggled to develop techniques for measuring the effectiveness of their marketing campaigns. Methods currently utilized by marketing professionals include business reply cards and toll-free numbers that prospects can use to request more information, and surveys conducted by third parties who poll a random subset of recipients on the success of the message. However, these methods fall short of ideal because they require the prospect to take an active step after viewing the information. Many prospects may fail to respond or, if they do, the time lag between the prospect's receipt of the message and his response can compromise the value of the information; the prospect may, for example, fail to recall what he learned about the product from the marketing material. More generally, prospects' responses tend to be very subjective and difficult to quantify, thereby limiting their usefulness.

Sales-oriented businesses themselves seek better ways to quantify the success of their marketing campaigns and the information they distribute about their products. Businesses expend significant resources to facilitate a sales opportunity, and wish to allocate resources as efficiently as possible. It is crucial to correctly determine how far along in the sales cycle an opportunity has progressed, given that different resources are appropriate depending on the phase of the sale. For example, consider a sales engineer who delivers a product demonstration. If this is done too early in the selling process, the message may simply be lost on a prospect who would have benefited from higher-level marketing information, such as a brochure.

Sales force automation (SFA) systems help to automate various tasks in the sales cycle and can also shorten the cycle. SFA systems provide customer-relationship management functions that record events transpiring during the sales cycle, assist a salesperson in keeping the sales process tightly organized, and provide a mechanism for easily disseminating sales and marketing information. Successful use of SFA systems, however, requires accurate information. Current SFA systems rely on the salesperson's intuition of the current phase of the sales cycle. This subjective determination carries with it a high risk of an incorrect assessment, which can result in less than optimal resource allocation and undermine the usefulness of the SFA system.

### SUMMARY OF THE INVENTION

The present invention provides systems and methods which allow business and marketing professionals to quantitatively measure the success of distributed marketing information and the quality of the sales opportunity at any given phase in the sales process. In some embodiments, the invention takes the form of software delivered as a service that allows professionals to create rich media presentations for prospects to view on demand, and which contain an embedded facility that quantitatively measures the impact of the communication on the prospect.

This approach represents a significant improvement over traditional methods. Embodiments of the invention automatically capture statistics while the prospect is viewing the information. This eliminates the need for the prospect to take an active step for feedback to be generated. In addition, the statistics give a quantitative view of the success of the information, providing a more effective and accurate assessment of the marketing initiative than the subjective responses of the prospects. Furthermore, the results gathered by the invention are directly correlated to the message.

The invention can be integrated with an SFA system to optimize the system's performance by tying quantitative measurements of success to particular phases of the sales cycle. The integration with the SFA system allows the statistics captured by embodiments of the invention to immediately be incorporated into the SFA flow. Sales agents can then use this data to make educated decisions based on the phase of the sales cycle, and allocate sales resources accordingly.

Accordingly, embodiments of the present invention facilitate the quantitative measurement of the success of a marketing message, and correlate this measurement with the quality of a sales opportunity throughout the sales process. In various embodiments, the invention provides means to create a media-rich marketing presentation, monitor and record viewer responses to the presentation, and utilize the obtained information to assess the effect of the presentation and/or estimate the phase within the sales cycle.

In one aspect, the invention provides a system for monitoring a viewer response to a presentation. The system includes a composer for creating a slide presentation; a host for storing the presentation and providing it to a viewer (e.g., over a computer network); and a tracking editor, that is, a facility for associating tracking commands with at least some of the slides. The tracking commands obtain viewer-response data when the presentation is accessed by the viewer. The system may also contain a facility for recording these viewer-response data.

In some embodiments, the system includes an audio capture device for recording an audio narration for at least some of the slides. The host system synchronizes each audio narration clip with an associated visual slide, and stores the resulting audio-visual presentation in memory for subsequent access by the viewer.

The tracking commands cause the recording of one or more viewer-response parameters upon execution. Such parameters include, but are not limited to, an indication whether an action is taken by the viewer in response to a slide, a time interval during which a slide is being viewed, a time interval during which the audio associated with a slide is playing, an indication whether the viewer skips a slide, an indication whether an attachment associated with a slide is launched by the viewer, the order in which slides are viewed, and the total time spent by the viewer viewing the presentation. In some embodiments, a plurality of viewer-response parameters are recorded. The system may contain a module for deriving statistics from one or more parameters throughout access of the presentation by the viewer. These statistics may correspond to user actions in connection with all slides with which the parameter is associated, and may include, for example, an average slide viewing time, or an average number of times a slide is viewed. Moreover, statistics may be derived from one or more viewer-response parameters across a plurality of viewers.

In another aspect, the invention provides a system for rendering a slide presentation capable of being monitored for viewer response. The system includes a computer processor; a memory for storing a plurality of visual slides; and an editor for associating tracking commands with at least some of the slides, such that, upon access of the presentation by a viewer, the tracking commands obtain viewer-response data, e.g., in the form of one or more viewer response parameters. The editor may also facilitate the creation of the visual slides. In various embodiments, the system further includes an SFA/CRM system, which recommends a sales step based at least in part on the viewer-response parameters.

In a third aspect, the invention provides a method for facilitating the monitoring of a viewer response to a presentation. The method involves creating a plurality of visual slides, and associating tracking commands with some or all of the slides. In some embodiment, it also includes recording audio narration portions for some of the slides, and associating said portions with the slides to which they pertain.

In yet another aspect, the invention comprises a method of monitoring viewer response to a presentation. The method includes providing a presentation of one or more slides with associated tracking commands that obtain viewer-response data upon execution; and facilitating the provision of the presentation to one or more viewers, and the recording of viewer-response data. The presentation may be a marketing presentation. In some embodiments, the method further involves assessing the success of the marketing message, based on statistics derived from viewer-response data across multiple viewers. Viewer-response data may also be used to estimate the phase of the sales cycle. In certain embodiments, viewer-response data are provided to an SFA/CRM system, which may determine the phase in the sales cycle and/or recommend a sales step based at least in part on the viewer-response data.

### BRIEF DESCRIPTION OF THE DRAWINGS

The foregoing discussion will be understood more readily from the following detailed description of the invention when taken in conjunction with the accompanying drawings.

FIG. 1 schematically illustrates a system for monitoring the response of a viewer to a marketing presentation according to one embodiment of the invention.

FIG. 2 schematically illustrates a system for creating a marketing presentation and facilitating the monitoring and analysis of the response of a viewer to the presentation according to one embodiment of the invention.

FIG. 3 is a flow chart illustrating a method for creating a marketing presentation and facilitating the monitoring and analysis of the response of a viewer to the presentation according to one embodiment of the invention.

### DETAILED DESCRIPTION OF THE INVENTION

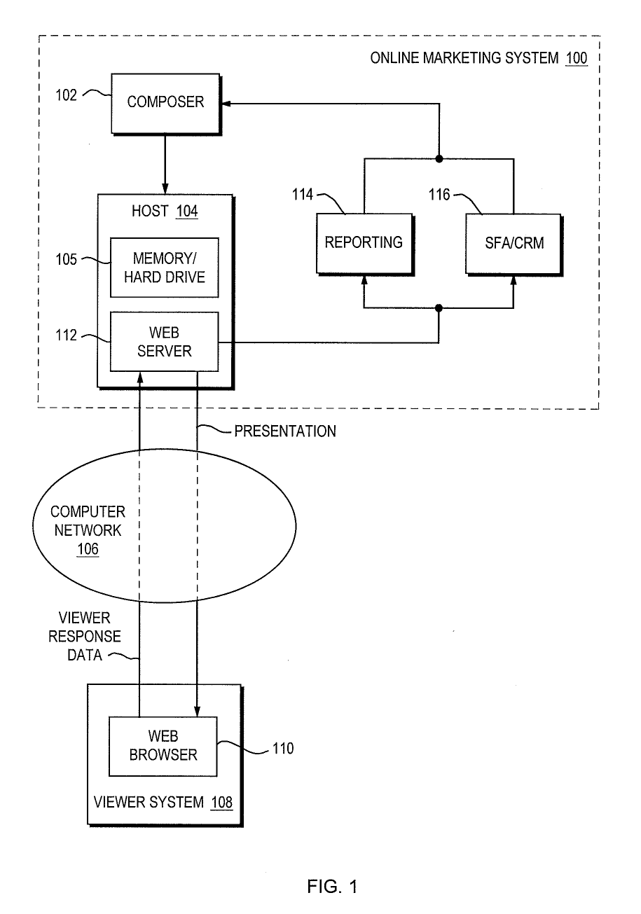

Refer first to FIG. 1, which provides a high-level overview of an online marketing system 100 according to one embodiment. The system 100 contains a composer 102 module facilitating the creation of a marketing presentation containing one or more visual slides. A host 104 converts this presentation, if applicable, to a web-friendly format, and stores it in volatile memory or nonvolatile storage (e.g., a hard drive) 105. The composer 102 or the host 104 has functionality, described in greater detail below, to associate tracking commands with the individual slides. These commands, if later executed during viewing of the presentation, trigger the recording of parameters relating to the viewer's response. The host 104 can convert each slide into a graphic image file capable of being transmitted over a computer network 106, such as the Internet, and establish, via the network 106, a connection with viewer system 108. Upon receipt of a request from a web browser 110, running as an executing application on viewer system 108, a web server 112 implemented on the host 104 causes the marketing presentation to be uploaded to the browser 110. In some embodiments, the host 104 extracts the title of each slide and stores it in a database in an active table-of contents, which allows the viewer to navigate the presentation.

As the viewer watches the presentation, response data are generated and returned to the web server 112, which facilitates tracking and recording thereof. In one embodiment, the response data are compiled by a reporting module 114, which generates a report for subsequent view on demand via the composer 102. In another embodiment, the viewer response data is forwarded to a sales force automation (SFA) or customer relationship management (CRM) system 116, which analyzes it to determine the success of the marketing presentation and/or the phase of the sales cycle. The SFA/CRM system 116 may also initiate communication to a customer using viewer system 108, for instance, by sending an email containing a link to the presentation via web server 112 to the viewer system 108.

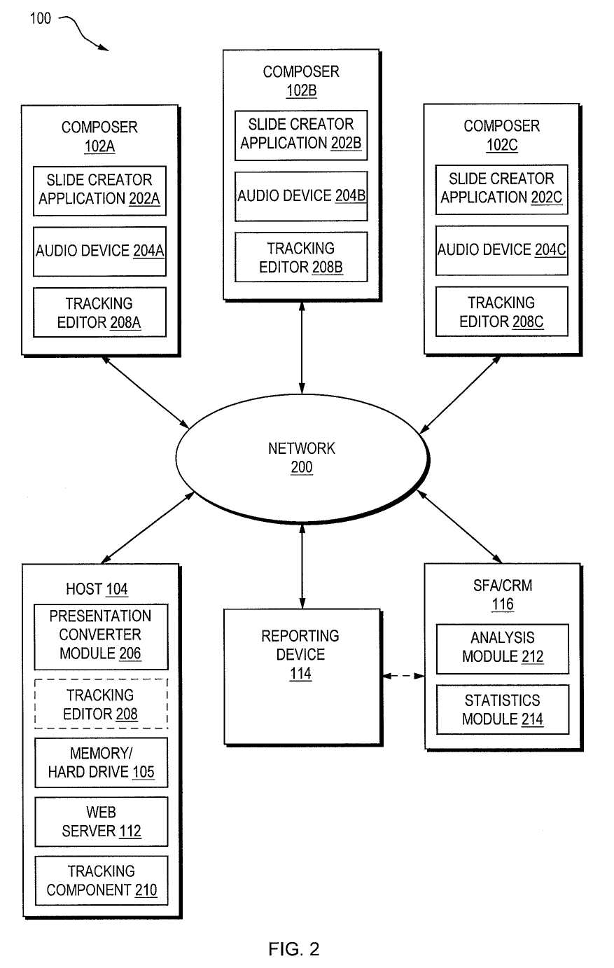

The various components of the online marketing system 100 can be implemented in any feasible system architecture. In some embodiments, composer 102, host 104, and reporting module 114 and/or SFA/CRM system 116 are all installed on a single computer. For example, the functionalities of the composer, host, and reporting module for creating a presentation, associating tracking commands, providing the presentation to a viewer, and recording and analyzing viewer-response data may be implemented as various software modules, stored in the nonvolatile memory of a single general-purpose computer having a computer processor and associated memory, as well as nonvolatile memory such as a hard drive. In other embodiments, these components are implemented on two or more interconnected computers. FIG. 2. provides an example of such a network architecture. In this embodiment, system 100 includes a plurality of composers representatively indicated as 102A, 102B, 102C (collectively, 102), which are in communication with a host 104 via a computer network 200. Depending on the size and needs of the organization utilizing system 100, the scope of the computer network 200 may vary. For example, the network 200 may be a local area network (LAN), e.g., the intranet of a company, or it may be a global area network (WAN) such as the Internet. This distributed architecture allows multiple marketers (each using one of the composers 102) to generate presentations remotely, and upload them to a central host 104. The SFA/CRM component 116 can be located on yet another computer. Alternatively, it can be integrated within the host 104. Embodiments of the invention include systems wherein the viewer system 108 is integrated with the host 104, and a prospective customer can view the presentation directly on the computer where it is stored, as opposed to downloading it over a network. Such a system may, for instance, be employed in a store, where it may serve as an “electronic sales agent” that provides a prospect with detailed product and pricing information via a slide presentation.

FIG. 2 further details the individual components of system 100. To facilitate the creation of slide presentations, each composer 102 includes a slide-creator application 202, which may be off-the shelf software, such as, for example, POWER POINT, LOTUS or WORD. Slides created on a composer 102 using one or more of the slide-creator applications 202 may be combined into a single presentation. In general, slides may contain any combination of rich text, graphics, text in HTML format, video files, interactive text, or any other type of compatible multimedia components.

The slide presentation may be supplemented by audio-narrative, utilizing an audio capture device 204 associated with composer 102. The device 204 can, for example, be a computer microphone, or a telephone connected to the computer of composer 102. Typically, a narrator records audio portions for each slide into device 204 while viewing the slide presentation. Digital audio files of the narration are then sent along with the visual presentation to host 104, which synchronizes and combines each audio clip with the associated file. This functionality can, for example, be implemented in a presentation converter module 206 on host 104, which generates a web-browser-readable audio-visual presentation from the files obtained from the composer 102. Module 206 also enables the narrator to interactively view the slides and listen to the associated audio portions via a composer 102; that is, the presentation converter module 206 converts each slide into a graphic image file that is transmitted, along with the synchronized audio file, over the network 200 to the narrator's composer. The creation of the visual presentation and the recording of voice portions can, but need not, take place on the same composer 102. For example, the narrator may download a visual presentation previously created on composer 102A and stored on host 104, and record his voice with an audio capture device 204B. Further detail on systems and methods for recording audio portions and synchronizing them with the respective slides is provided in U.S. Pat. No. 6,968,506, which is hereby incorporated by reference in its entirety.

A tracking editor 208, implemented on composer 102 or host 104, facilitates the association of tracking commands with the slides, thereby enabling the monitoring and recording of viewer responses, and the compilation of detailed quantitative viewer statistics derived therefrom. The tracking commands correspond to functions whose execution gathers, or facilitates gathering of, information relevant to the viewer's experience with a presentation. The tracking commands may, for instance, be encoded in MICROSOFT Visual Basic for Applications (VBA), a programming language supported by MICROSOFT OFFICE and similar products and designed for the customization and enhancement of such software packages. The commands may be executed client-side (at the viewer system 108), e.g., using JavaScripts, or server-side (on host 104), e.g., using Common Gateway Interface (CGI) programs.

Viewer behavior that can be tracked includes information about the viewer's navigation through a slide presentation, and can apply to particular slides or the entire presentation. For example, a timer function associated with a particular slide can be triggered when the viewer first views that slide and will terminate when the viewer moves on to the next slide, thereby recording the amount of time spent on that slide. Slides can be grouped and viewing times aggregated for each group, or for the presentation as a whole. The editor 208 may also record the order in which slides are viewed, and which slides are viewed more than once. Additional parameters that may be recorded include the duration of time the audio was played while the presentation was viewed, the start time of the view, the amount of time the viewer spent on each slide, whether some slides were skipped or not viewed, the order in which the slides were viewed, the duration of the overall view, and whether an attachment in the presentation was launched by the viewer.

In addition, a polling feature may be included in the editor 208 to solicit viewer input, e.g., through text input fields or selection buttons (whose timing and appearance can be selected by the presentation developer using editor 208) embedded in the presentation. For example, after marketing information is presented, questions may be posed regarding how a prospective might use of the product under consideration, such as for training, information dissemination, technical support, etc. Furthermore, the timing and content of the viewer input that is solicited may be made dependent on other tracked information; for example, viewer input may be solicited only for slides viewed for more than a threshold time, or if the viewer ignores more than one solicitation for input, the remainder can be deleted from the presentation before they appear. Content may also be refined in response to user input. For example, if the prospect indicates an interest in training, she may be asked whether she uses a Learning Management System (LMS), and, if applicable, which type of system.

Viewer responses, including answers to polling questions, are sent from the web browser 110 on which the viewer watches the presentation through the network 106 to the web server 112 (either immediately following each user action or on a batch basis, following completion of the presentation), and are recorded by a tracking component 210 of host 104. Typically, tracking component 210 allows tracking information associated with each event to be stored in a database or a log file. The tracking component 210 may, for example, utilize the APACHE Log4J Java package to generate such a log file. In a batch implementation, data can be stored in a temporary log file on the viewer system 108, and reported to the web server 112 at a later time, e.g., when the presentation is exited. A log file may include a client ID (e.g., the IP address of the viewer system 108 and/or an identification of the employed web browser 110), the date and time, and a descriptor of the transaction or event (e.g., a viewer request for the next slide or the playing of an audio portion). Alternatively, critical events may be logged directly to the database, and reported upon request.

Viewer response data gathered by the tracking component 210 can be sent to and further processed by a reporting module 114 and/or a SFA/CRM system 116, which may, in some embodiments, be integrated with the tracking component. From the detailed information about the viewer response to and navigation through each of the slides, the components 114, 116 may compile information about the presentation as a whole. Such information may include the average length of time the viewer views the slides, or a ranking of the slides by viewing activity, e.g., the length of time a slide is viewed or the number of times a slide is viewed. The information recorded for a particular presentation can also be aggregated and averaged across multiple views of that presentation by the same viewer or a plurality of viewers.

The reporting module 114 may simply present viewer-specific and/or aggregate statistical information in a format convenient for the user of system 100, and emphasizing parameters selected from the user. SFA/CRM system 116, however, utilizes a particular viewer's experience with a presentation, as reflected in the tracked parameters, in order to identify or select among possible next steps in the sales cycle. In particular, an analysis module 212 of the SFA/CRM system 116 can infer the prospect's general interest in the presentation, determine the aspects she is particularly interested in, and estimate therefrom the current phase of the sales cycle. For example, if a viewer skips through most of the slides and, after briefly viewing a slide with price details, exits the presentation, she is likely not interested in the presented product or service. On the other hand, if she spends a long time on a product specification slide, and then moves on to view pricing information, she may be ready to purchase the product. Analysis module 212 utilizes this information to recommend a next step for the viewer (e.g., send her a proposal) as a sales prospect.

The analysis module 212 can also be configured to make recommendations concerning the content of the presentation based on the statistics discussed above. Thus, SFA/CRM system 116 can include a statistics module 214, which aggregates responses to the presentation across viewers. For example, it can identify the most common path through the slides in the presentation, and determine the average percentage of audio listened to for each slide and the percentage of viewers who watched a particular slide. This data provides a statistical metric for the success of the marketing message, and can be used to refine the presentation. For example, if a slide is skipped by the vast majority of viewers, it may be deleted from the presentation, and if slides are viewed out of order, a rearrangement of the slides may be advisable.

In addition to gathering statistics, the SFA/CRM system can be used as a platform for disseminating the marketing material and tracking the results. The system may store contact information of prospects, along with their particular interests. Marketing presentations may be sent to potentially interested prospects for their perusal, and the automatically captured viewer behavior is returned to the SFA/CRM system, and integrated in the analysis to provide further insight and allow for better sales positioning.

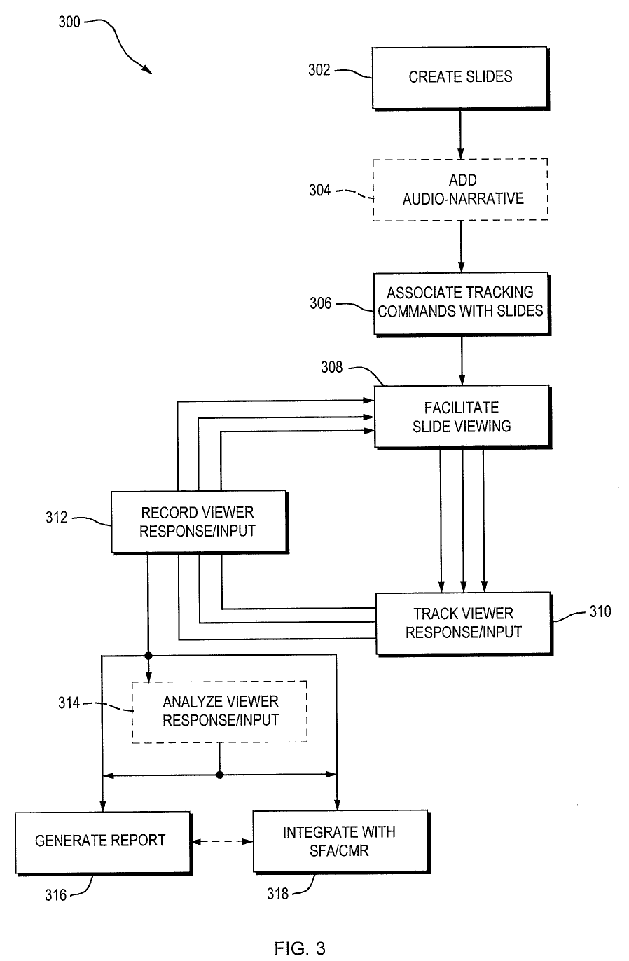

The operational flow may be best appreciated with reference to FIG. 3, which illustrates the steps of a method 300 for monitoring and utilizing viewer response to a presentation. In a first step 302, a presentation containing one or more visual slides is created. Optionally, the presentation can be supplemented with audio-narrative (step 304). Each slide is associated with one or more tracking commands for monitoring viewer response (step 306). The resulting tracking-enabled visual or audio-visual presentation is subsequently made available for viewing (step 308). While the presentation is viewed, the viewer response and/or input is tracked (step 310) and recorded (step 312). Typically, the provision of slides, execution of associated tracking commands, and recording of the viewer response take place in an iterative manner. For example, a viewer may respond to a slide by clicking on the “Next”-button, which triggers the next slide to be sent and rendered for viewing. The recorded viewer response data may, optionally after further analysis (step 314), be compiled into a report (step 316). Alternatively or additionally, it can be integrated into the operations of a SFA/CRM system (step 318).

It will be seen that the foregoing systems and methods provide for the quantification of the success of a marketing presentation utilizing viewer response information. The terms and expressions employed herein are used as terms of description and not of limitation, and there is no intention in the use of such terms and expressions of excluding any equivalents of the features shown and described or portions thereof. Instead, it is recognized that various modifications are possible within the scope of the invention claimed.

What is claimed is:

1. A system for monitoring a viewer response to a presentation, the system comprising:
(a) a composer facilitating creation of a presentation containing at least one visual slide;
(b) a host for storing the presentation and facilitating provision thereof to a viewer; and
(c) a facility for associating tracking commands with at least some of the slides, the tracking commands obtaining viewer-response data when the presentation is accessed by a viewer.

2. The system of claim 1 further comprising a facility for recording viewer-response data obtained upon execution of the tracking commands.

3. The system of claim 1 wherein the composer comprises an audio capture device for capturing an audio narration for at least some of the slides, the host system synchronizing each audio narration clip with an associated visual slide and storing the resulting audio-visual presentation in the memory of the host system for subsequent access by a viewer.

4. The system of claim 1 wherein the tracking commands, when executed, cause recording of at least one viewer-response parameter.

5. The system of claim 4 wherein the at least one viewer-response parameter indicates whether an action is taken by the viewer in response to a slide.

6. The system of claim 4 wherein the at least one viewer-response parameter comprises a time interval during which the viewer views a slide.

7. The system of claim 4 wherein the at least one viewer-response parameter comprises an indication whether the viewer skips a slide.

8. The system of claim 4 wherein the at least one viewer-response parameter comprises a time interval during which audio associated with a slide is playing.

9. The system of claim 4 wherein the at least one viewer-response parameter comprises an indication whether an attachment associated with a slide is launched.

10. The system of claim 4 wherein the at least one viewer-response parameter comprises an order in which the viewer views the slides.

11. The system of claim 4 wherein the at least one viewer-response parameter comprises a total time spent by the viewer viewing the presentation.

12. The system of claim 4 wherein the tracking commands, when executed, record a plurality of viewer-response parameters, and further comprising a module for compiling statistics derived from at least one of the parameters throughout access of the presentation by the viewer.

13. The system of claim 12 wherein the statistics derived from a parameter correspond to user actions in connection with all slides with which the parameter is associated.

14. The system of claim 12 wherein the statistics include an average slide viewing time.

15. The system of claim 12 wherein the statistics include an average number of times a slide is viewed.

16. The system of claim 12 wherein the statistics are derived from at least one of the parameters throughout access of the presentation by a plurality of viewers.

17. A system for rendering slide presentations capable of being monitored for viewer response, the system comprising:
(a) a computer processor;
(b) a memory for storing a plurality of visual slides; and
(c) an editor for associating tracking commands with at least some of the slides, the tracking commands obtaining viewer-response data when the presentation is accessed by a viewer.

18. The system of claim 17 wherein the editor also facilitates creation of the visual slides.

19. The system of claim 17 wherein the tracking commands, when executed, cause recording of at least one viewer-response parameter.

20. The system of claim 19 further comprising a SFA/CRM system, responsive to the viewer-response parameters, for recommending a sales step based at least in part thereon.

21. A method of facilitating monitoring of viewer response to a presentation, the method comprising the steps of:
(a) creating a plurality of visual slides; and
(b) associating tracking commands with at least some of the slides, the tracking commands obtaining viewer-response data when the presentation is accessed by a viewer.

22. The method of claim 21 further comprising the steps of recording audio narration portions for at least some of the slides, and associating each of the portions with the slide to which it pertains.

23. A method of monitoring viewer response to a presentation, the method comprising the steps of:
(a) providing a presentation containing at least one slide, at least one of the slides having tracking commands associated therewith, the tracking commands obtaining viewer-response data when the presentation is accessed by a viewer;
(b) facilitating provision of the presentation to the viewer; and
(c) facilitating the recording of viewer-response data obtained upon execution of the tracking commands.

24. The method of claim 23 wherein the presentation is a marketing presentation, and further comprising the step of estimating the phase of the sales cycle based on the viewer-response data.

25. The method of claim 23 further comprising the step of compiling statistics derived from the viewer-response data.

26. The method of claim 25 wherein the viewer-response data is obtained from a plurality of viewers.

27. The method of claim 26 wherein the presentation is a marketing presentation, and further comprising the step of assessing the success of the marketing message.

28. The method of claim 23 wherein the presentation is a marketing presentation, and further comprising the step of providing the viewer-response data to an SFA/CRM system.

29. The method of claim 28 further comprising the step of recommending, by the SFA/CRM system, a sales step based at least in part on the viewer-response data.

30. The method of claim 28 further comprising the step of determining, by the SFA/CRM system, the phase of the sales cycle.
